(19) United States
(12) Patent Application Publication
(10) Pub. No.: US 2016/0018643 A1
(43) Pub. Date: Jan. 21, 2016

(54) WEARABLE DISPLAY DEVICE AND CONTROL METHOD THEREOF

(71) Applicant: LG ELECTRONICS INC., Seoul (KR)

(72) Inventors: Eunhyung CHO, Seoul (KR); Doyoung LEE, Seoul (KR)

(73) Assignee: LG ELECTRONICS INC., Seoul (KR)

(21) Appl. No.: 14/533,631

(22) Filed: Nov. 5, 2014

(30) Foreign Application Priority Data
Jul. 17, 2014 (KR) 10-2014-0090340

(51) Int. Cl. G02B 27/01; G06K 9/00

(52) U.S. Cl. CPC G02B 27/0172; G06K 9/00208; G06K 9/00335; G06K 9/00677; G02B 2027/0178; G06K 2209/25

(57) ABSTRACT

Disclosed is a control method of a wearable display device. The control method includes displaying at least one content at a first position on a display unit of the wearable display device, sensing at least one real object located outside of the wearable display device, identifying at least one event object by matching the at least one sensed real object with a predetermined object set, determining a second position on the display unit adjacent to a position on the display unit corresponding to the at least one identified event object and moving a display position of the at least one content from the first position to the determined second position on the display unit.

This application claims the benefit of Korean Patent Application No. 10-2014-0090340, filed on Jul. 17, 2014, which is hereby incorporated by reference as if fully set forth herein.

### BACKGROUND OF THE INVENTION

1. Field of the Invention

The present specification relates to a wearable display device and a control method thereof.

2. Discussion of the Related Art

FIG. 1 shows one example of a wearable display device according to the present specification.

There is used a wearable device to be worn on the body of a user. For example, FIG. 1 shows a wearable Head Mounted Display (HMD) as one example of a wearable display device 100. In addition, the wearable display device, as exemplarily shown in FIG. 1, has a shape similar to glasses to allow a user to wear the wearable display device as needed.

An HMD may be classified into an open-view type that allows a user to view a real object of the real world and a virtual reality image together or a closed view type that allows a user to view only a virtual reality image. An open view type wearable display device may provide a user with increased immersion using Augmented Reality (AR) or Mixed Reality (MR).

For example, the wearable display device 100 may display at least one content on a display unit 120. In addition, a user of the wearable display device 100 may walk along the street while enjoying the content. In this case, since the user is immersed in the content on the display unit 120, there is a risk of accidents due to external factors, such as traffic accidents. With regard to this, a method of providing an alarm based on a distance to an external rear object has been studied. However, there is needed a method of more accurately recognizing risk factors and efficiently apprising a user of such risk factors.

### SUMMARY OF THE INVENTION

Accordingly, the present specification is directed to a wearable display device and a control method thereof that substantially obviate one or more problems due to limitations and disadvantages of the related art.

One object of the present specification is to provide an improved user interface capable of controlling display of content based on a detected real object.

Additional advantages, objects, and features will be set forth in part in the description which follows and in part will become apparent to those having ordinary skill in the art upon examination of the following or may be learned from practice. The objectives and other advantages may be realized and attained by the structure particularly pointed out in the written description and claims hereof as well as the appended drawings.

In accordance with one embodiment of the present specification, wearable display device includes a display unit configured to display at least one content, an image sensing unit configured to sense at least one real object located outside of the wearable display device, and a processor configured to control the display unit and the image sensing unit, wherein the processor is further configured to display the at least one content at a first position on the display unit, identify at least one event object by matching the at least one real object sensed by the image sensing unit with a predetermined object set, determine a second position on the display unit adjacent to a position on the display unit corresponding to the at least one identified event object and move a display position of the at least one content from the first position to the determined second position on the display unit, and wherein the at least one content and the at least one event object are irrelevant to each other.

In accordance with another embodiment of the present specification, a control method of a wearable display device, includes displaying at least one content at a first position on a display unit of the wearable display device, sensing at least one real object located outside of the wearable display device, identifying at least one event object by matching the at least one sensed real object with a predetermined object set, determining a second position on the display unit adjacent to a position on the display unit corresponding to the at least one identified event object and moving a display position of the at least one content from the first position to the determined second position on the display unit, wherein the at least one content and the at least one event object are irrelevant to each other.

It is to be understood that both the foregoing general description and the following detailed description of the present specification are exemplary and explanatory and are intended to provide further explanation of the present specification as claimed.

### BRIEF DESCRIPTION OF THE DRAWINGS

The accompanying drawings, which are included to provide a further understanding of the present specification and are incorporated in and constitute a part of this application, illustrate embodiment(s) of the present specification and together with the description serve to explain the principle of the present specification. In the drawings:

FIG. 1 is a view showing one example of a wearable display device;

FIG. 2 is a view showing a configuration of a wearable display device according to one embodiment;

FIG. 3 is a view showing a situation in which a user of a wearable display device according to one embodiment crosses the street at a crosswalk;

FIG. 4 is a view showing adjusted content display on a wearable display device according to one embodiment;

FIG. 5 is a view showing movement of a display position of content;

FIG. 6 is a view showing movement of a real object and movement of a display position of content according to one embodiment;

FIG. 7 is a view showing a display position of content according to one embodiment;

FIG. 8 is a view showing variation of a display position of content depending on movement of a user;

FIG. 9 is a view showing a cancel interface according to one embodiment; and

FIG. 10 is a flowchart showing a control method of a wearable display device according to one embodiment of the present specification.

### DETAILED DESCRIPTION OF THE INVENTION

Hereinafter, although embodiments will be described in detail with reference to the accompanying drawings and content described in the accompanying drawings, the scope of the present specification to be claimed is not limited or restricted by the embodiments.

Although the terms used in the present specification are selected, as much as possible, from general terms that are widely used at present while taking into consideration the functions, these terms may be replaced by other terms based on intensions of those skilled in the art, customs, emergence of new technologies, or the like. Also, in a particular case, terms that are arbitrarily selected by the applicant may be used. In this case, the meanings of these terms may be described in corresponding description parts of the present specification. Accordingly, it should be noted that the terms used herein should be construed based on practical meanings thereof and the whole content of this specification, rather than being simply construed based on names of the terms.

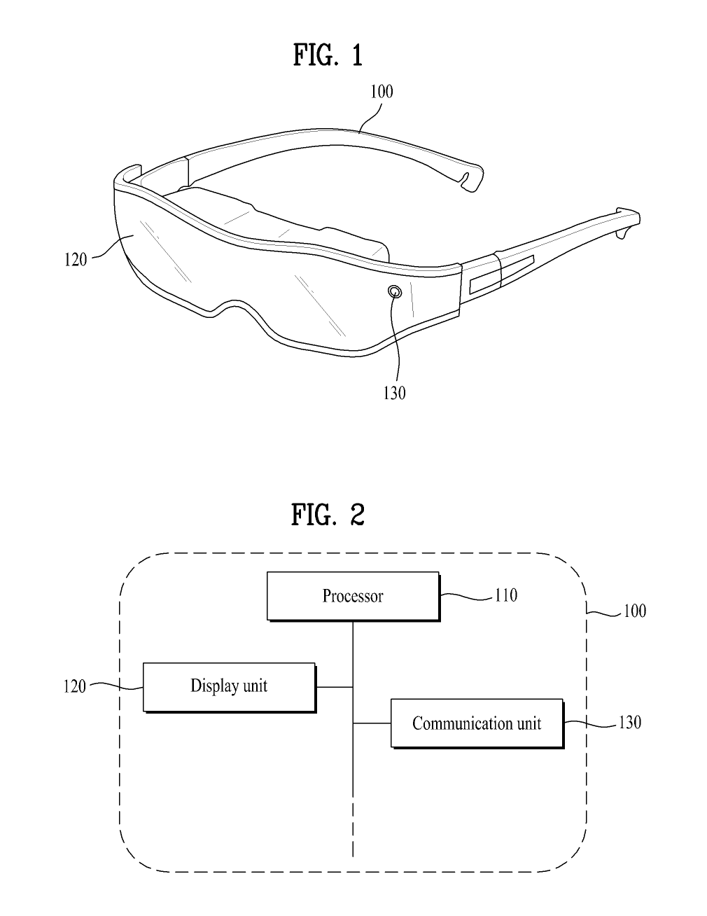

FIG. 1 shows one example of a wearable display device.

In FIG. 1, the wearable display device 100 in the form of glasses is shown. However, in addition to the glasses type, the wearable display device 100 of the disclosure may include a helmet type, a cap type, a goggles type and any one of various shapes of head mounted displays that may be mounted on the head. In addition, the wearable display device 100 may include a contact lens or a smart contact lens including a display. The wearable display device 100 may display one or more content while not obscuring an external object. The wearable display device 100 may provide a user with augmented reality (AR) and/or mixed reality (MR).

FIG. 2 is a view showing a configuration of the wearable display device according to one embodiment.

The wearable display device 100 of the disclosure may include a display unit 120 configured to display at least one content, an image sensing unit 130 configured to sense at least one real object located outside of the wearable display device 100 and a processor 110 configured to control the display unit 120 and the image sensing unit 130.

The display unit 120 may include a lens, a projection plane, a projector and/or a prism. In addition, the display unit 120 may include any other transparent display units. In addition, the display unit 120 may be a lens located on the eyeball. The display unit 120 may display an image at the outside of the wearable display device 100 in real time.

The image sensing unit 130 may sense a real object present at the outside of the wearable display device 100. That is, the image sensing unit 130 may sense a real object present in a gaze direction of the user of the wearable display device 100. The image sensing unit 130 may sense an image using visible light, infrared light, ultraviolet light, magnetic fields and/or sound waves.

The processor 110 may control the display unit 120 and the image sensing unit 130. In addition, the processor 110 may control other components included in the wearable display device 100. The processor 110 may execute various applications by processing data of the wearable display device 100. The processor 110 may control the wearable display device 100 and the content executed in the wearable display device 100 based on a command.

In addition, the wearable display device 100 may further include other components not shown in FIG. 2. For example, the wearable display device 100 may further include a communication unit for communication with an external device. The communication unit may perform communication via a wired or wireless network and transmit and receive data. For example, for connection with a wireless network, the communication unit may use Wireless LAN (WLAN), IEEE 802.11 based WLAN communication, Wireless Broadband (WiBro), Worldwide Interoperability for Microwave Access (WiMAX), High Speed Downlink Packet Access (HSDPA), Bluetooth, Near Field Communication (NFC) and the like. In addition, the communication unit may be connected to the Internet via a wired/wireless network.

In addition, the wearable display device 100 may further include other components not shown in FIG. 2. For example, the wearable display device 100 may further include a memory, a power source, a housing, one or more sensors (for example, a touch sensor, an accelerometer, a gyro sensor, a geomagnetic sensor, a GPS sensor, a pressure sensor, an altimeter, or a proximity sensor), a voice receiving unit, a voice output unit and various other elements.

Meanwhile, FIG. 2 shows a configuration of the wearable display device 100 according to one embodiment in block diagram form, and separately shown blocks represent logically separated constituent hardware units. Thus, the constituent units of the above-described wearable display device 100 may be mounted as one chip or a plurality of chips according to design of the device.

Meanwhile, the wearable display device 100 of the present specification may be controlled based on various inputs. For example, the wearable display device 100 may include a physical button and may receive input via the physical button. In addition, the wearable display device 100 may include a voice receiving unit, and may perform voice recognition based on received voice and be controlled based on voice recognition. More specifically, the wearable display device 100 may perform voice recognition on a per syllable, word or sentence basis and may perform a function via combinations of recognized syllables, words or sentences. In addition, the wearable display device 100 may perform image analysis using the image sensor unit 130 and be controlled based on an analyzed image. The wearable display device 100 may include a touch sensing unit and be controlled based on touch input to the touch sensing unit. In addition, the wearable display device 100 may be controlled based on combinations of the above-described inputs.

Hereinafter, operations performed by the wearable display device 100 will be described with reference to FIGS. 3 to 10. The above-described components of the wearable display device 100 may be used in operations of the wearable display device 100 that will be described below. In the following description, operations of the wearable display device 100 may be described as being equal to operations of the processor 110. In addition, an event object and a real object may designate the same object.

FIG. 3 is a view showing a situation in which a user of the wearable display device according to one embodiment crosses the street at a crosswalk.

In FIG. 3, the user who wears the wearable display device 100 stands at a crosswalk. In addition, the wearable display device 100 displays content 210 on the display unit. Thus, the user may simultaneously view the content 210 and a real object 250 at the outside of the wearable display device 100 via the wearable display device 100. In the embodiment of FIG. 3, the real object 250 is a traffic light and indicates a stop signal. As exemplarily shown in FIG. 3, the content 210 is displayed at a position distant from the real object 250. In this case, the user is immersed in the content 210 and may not view change of a signal of the traffic light. In particular, when the user continuously walks without viewing a signal of the traffic light, there is a risk of traffic accidents. Therefore, there is needed a method of attracting a user's attention without hindering the user.

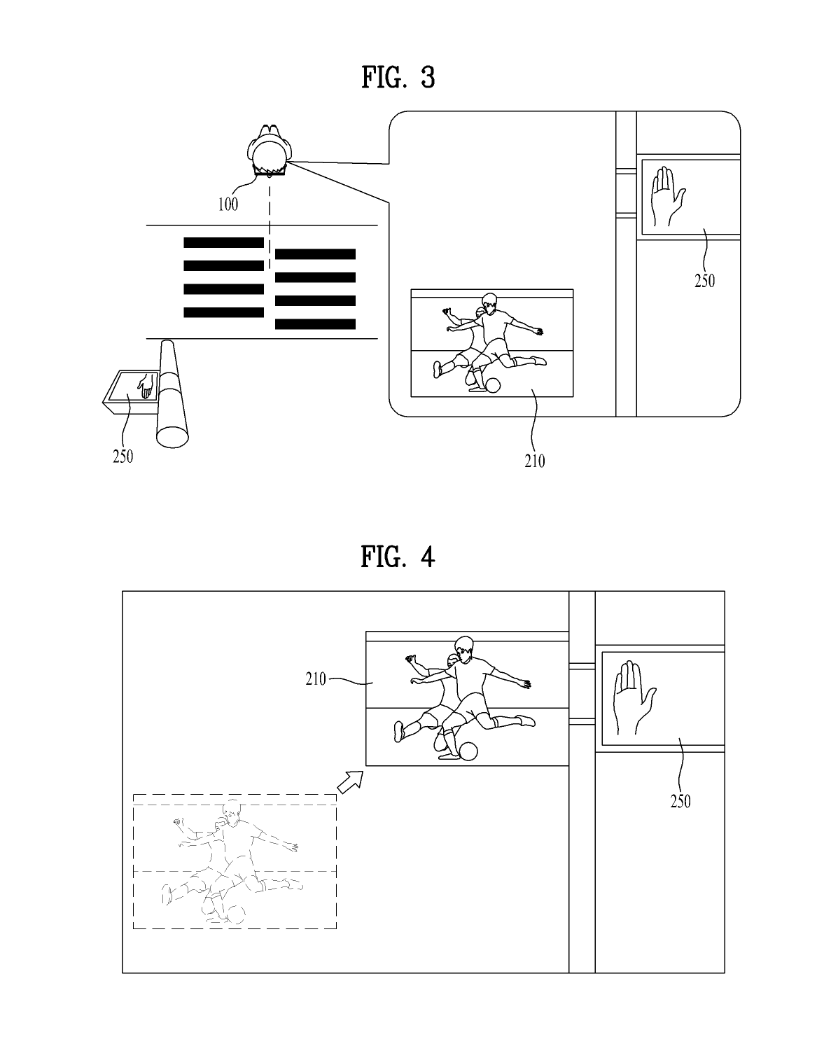

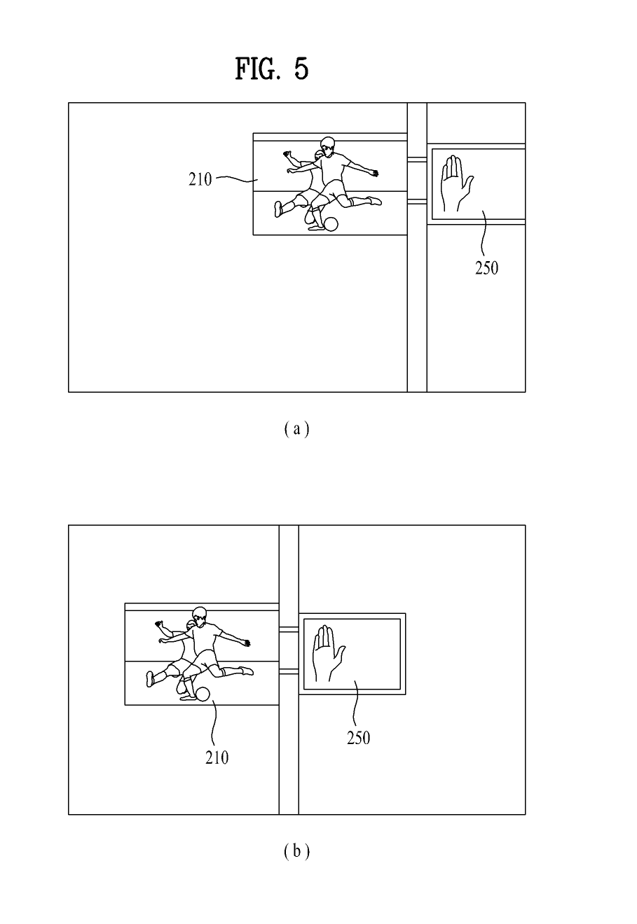

FIG. 4 is a view showing adjusted content display on the wearable display device according to one embodiment.

The wearable display device 100 of the present specification moves a display position of the content 210 to a position adjacent to the real object 250 in order to cause natural movement of the user's eyes. That is, the wearable display device 100 may sense at least one real object 250 using the image sensing unit. In addition, the wearable display device 100 may identify at least one event object by matching the sensed real object 250 with a predetermined object set. In addition, the wearable display device 100 may determine a position on the display unit adjacent to a position on the display unit of the wearable display device 100 corresponding to the identified event object. In addition, the wearable display device 100 may move a display position of the content 210 to the determined position.

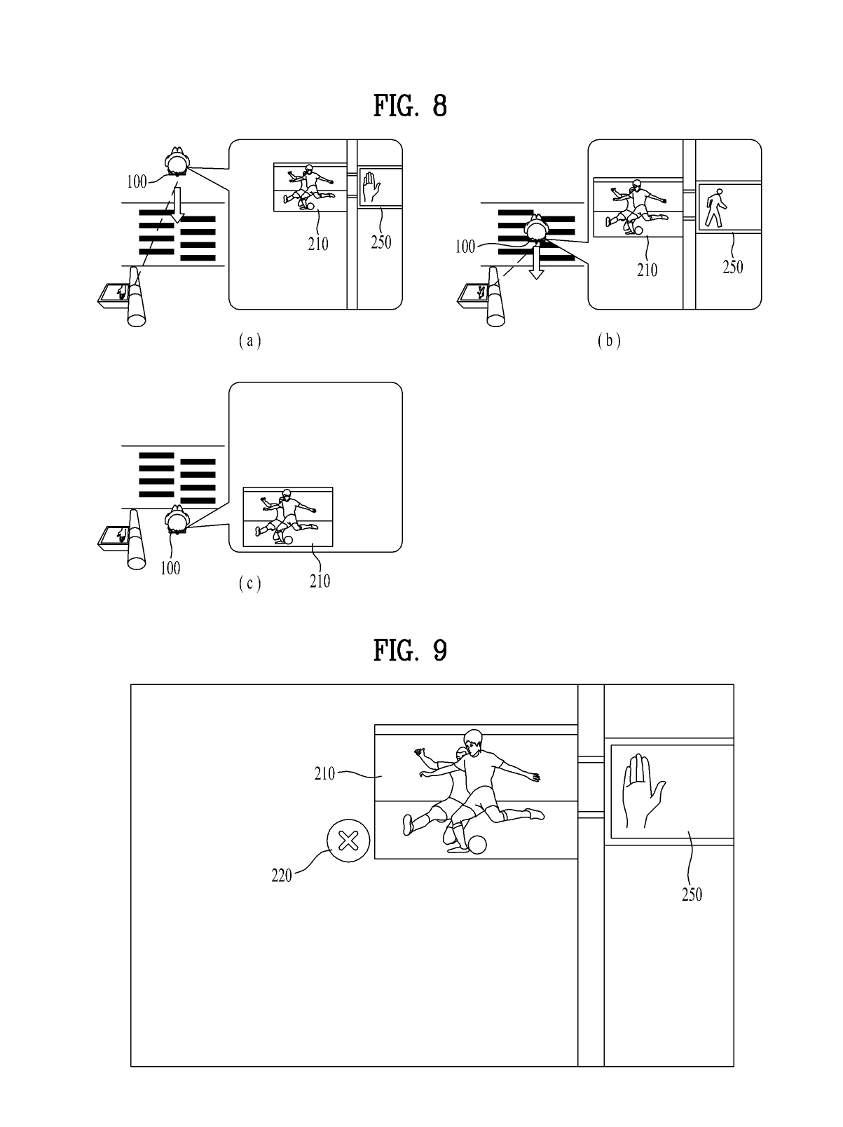

In FIG. 4, movement of the content 210 based on the eyes of the user of the wearable display device 100 is shown. More specifically, the wearable display device 100 senses a traffic light as the real object 250. In addition, the wearable display device 100 matches the traffic light with a predetermined object set. The predetermined object set may include various other objects as well as the traffic light. Each of the objects in the predetermined object set may include at least one of a number, a letter, a symbol, a 2D image and a 3D image. The predetermined object set may be set or stored by a manufacturer or a user. In addition, as will be described below with reference to FIG. 8, a new object may be added to the predetermined object set by an external device.

The predetermined object set may include at least one of objects associated with safety warnings (for example, a traffic signal, a traffic sign, a warning or a warning image), objects associated with user convenience (for example, a vehicle, a letter on a vehicle, a train number, a gate number, an address sign or a road sign) and objects associated with advertisement (for example, a product, an advertisement image, a product name or a building). The above-described object set is given by way of example and may include various other real objects that the user has to view.

In addition, the wearable display device 100 may sense a new image using the image sensing unit, receive selection of an external real object contained in the sensed image, and add the new external real object to the object set based on the selection. After sensing of the image, an interface for selection of the external real object may be provided to the user. For example, selection of the external real object may be performed based on user's eyes or hands. In addition, by adding the selected external real object to the object set, the wearable display device 100 may identify the corresponding external real object as an event object later. As such, the user may learn the new event object.

The wearable display device 100 may perform image processing (for example, expansion, reduction, rotation or color change) of the sensed real object 250. In addition, the wearable display device 100 may match the real object 250 with the predetermined object set based on at least one of a size, shape and color of the sensed real object 250 and identify the matched real object 250 as an event object. In FIG. 4, for example, the wearable display device 100 may identify a stop signal of the traffic light as an event object.

In FIG. 4, the wearable display device 100 may identify a position on the display unit corresponding to the identified event object. The wearable display device 100 may estimate a position on the display unit where the event object (the real object 250, i.e. the traffic light) will be indicated using the image sensing unit. In addition, the wearable display device 100 may determine a position adjacent to the position of the event object on the display unit. Here, the position adjacent to the position of the event object (hereinafter referred to as the “adjacent position”) may mean a position sufficiently close to the position of the event object so as to attract a user's attention. In addition, the wearable display device 100 may move a display position of the content 210 from an initial display position to the determined adjacent position. As such, the content 210 is displayed adjacent to the traffic light (the real object 250). In this case, the user can check a signal of the traffic light as the user's eyes are naturally moved based on movement of the content 210. In addition, the user may continuously enjoy the content 210.

In addition, the wearable display device 100 may consider a display size of the content 210 and a position of the event object upon determination of a position to which the content 210 will be moved. For example, as exemplarily shown in FIG. 4, the content 210 is moved to a position that is adjacent to the real object 250 and does not overlap with the real object 250. As such, the wearable display device 100 may move a display position of the content 210 such that the displayed content 210 does not overlap with the event object.

Moreover, the wearable display device 100 may gradually move a display position of the content 210 to the determined position. This gradual movement of the display position enables natural movement of the user's eyes to the event object. However, the wearable display device 100 may immediately move a display position of the content 210. In addition, the wearable display device 100 may provide a sound alarm through a sound output unit once a display position of the content 210 is moved. In addition, the wearable display device 100 may provide the user of the wearable display device 100 with feedback via vibration once a display position of the content 210 is moved.

In addition, upon display of the content 210 at the moved position, the wearable display device 100 may adjust at least one of brightness, transparency and size of the displayed content 210 to a predetermined value. For example, the wearable display device 100 may prevent the real object 250 from being covered by the displayed content 210 by adjusting brightness and/or transparency of the displayed content 210. In addition, the wearable display device 100 may prevent the real object 250 from being covered by the displayed content 210 by adjusting a size of the content 210.

As exemplarily shown in FIG. 4, the displayed content 210 is irrelevant to the real object 250. In other words, in FIG. 4, the content 210 is a soccer game broadcast and the real object 250 is the traffic light. The traffic light is the real object 250 associated with a situation of the user of the wearable display device 100. However, the traffic light is irrelevant to the soccer game broadcast. That is, the wearable display device 100 of the present disclosure may move a display position of the content 210 based on a position of the real object 250, but not change the content 210 based on the real object 250. More specifically, the content 210 is selected by the user and is not directly relevant to a situation of the user. On the other hand, since a display position of the content 210 may be moved based on the real object 250, the display position of the content 210 is directly relevant to a situation of the user. In this way, the displayed content 210 is irrelevant to the real object 250. In addition, even if the content 210 relevant to the real object 250 is displayed by chance, those skilled in the art will understand that such coincidence is not within the intended scope of the disclosure.

FIG. 5 is a view showing movement of a display position of content.

FIG. 5 shows a scene that the user of the wearable display device 100 views. In FIG. 5, the real object 250, i.e. the traffic light is identified as an event object. In addition, the wearable display device 100 displays the content 210 adjacent to the identified event object. As the user of the wearable display device 100 moves their eyes, a position of the event object in the scene that the user views (i.e. on the display unit) is moved. The wearable display device 100 may detect movement of the event object on the display unit and move a display position of the content 210 based on the detected movement of the event object.

For example, in (a) of FIG. 5, the real object (250) (here, the real object means an event object) is at the right side of the scene and the content 210 is displayed adjacent to the real object 250. In this case, the user may move their head to watch the moved content 210 more comfortably. As a result, as exemplarily shown in (b) of FIG. 5, the real object 250 may be moved to the center of the scene. The wearable display device 100 may detect movement of the real object 250 via image processing. As exemplarily shown in (b) of FIG. 5, the wearable display device 100 may move a display position of the content 210 based on movement of the real object 250.

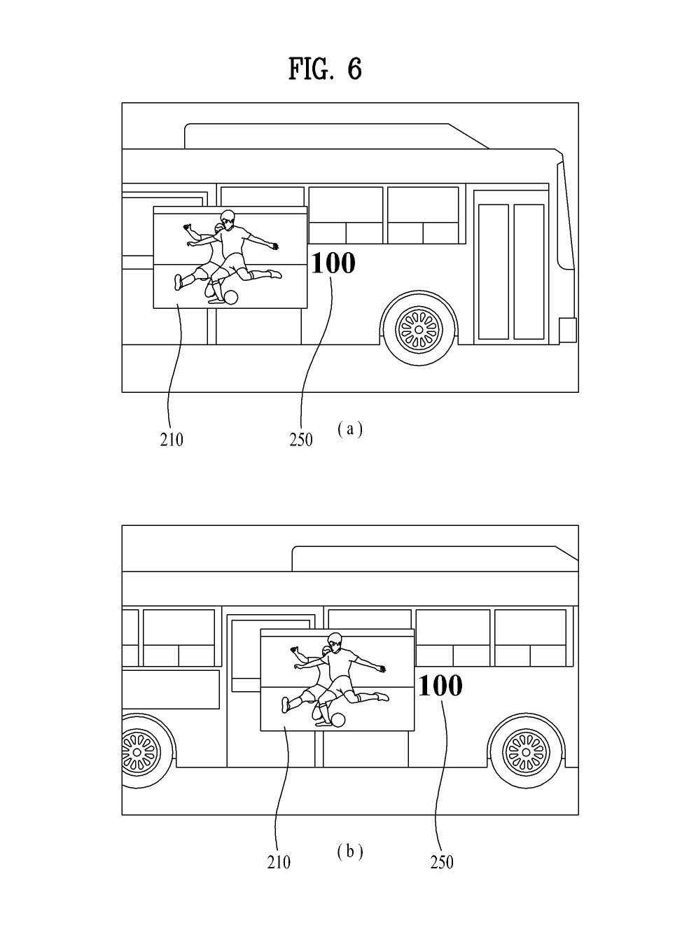

FIG. 6 is a view showing movement of a real object and movement of a display position of content according to one embodiment.

An event object may be moved even if the user's head is fixed. For example, in FIG. 6, a bus number as the real object 250 is identified as an event object. In this case, the real object 250 (here, the real object means an event object) is moved from the left to the right of the scene based on movement of a bus. As exemplarily shown in (a) and (b) of FIG. 6, a display position of the content 210 is moved based on movement of the real object 250.

As described above with reference to FIGS. 5 and 6, the wearable display device 100 may detect movement of an event object. Movement of the event object may be caused by movement of the event object or movement of the user. Meanwhile, the wearable display device 100 may determine a display position of the content 210 that will be moved based on movement of the event object. In addition, the wearable display device 100 may gradually move a display position of the content 210 such that the determined display position coincides with a current display position.

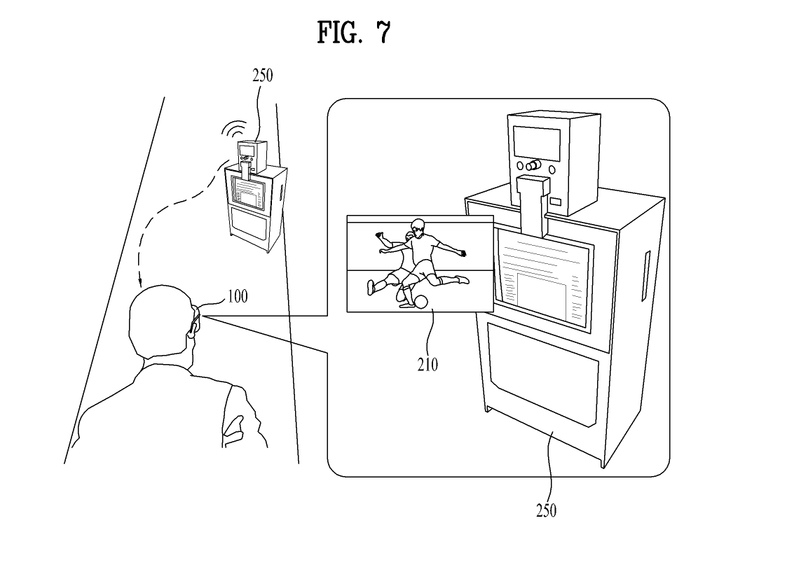

FIG. 7 is a view showing a content display position according to one embodiment.

The wearable display device 100 may include a communication unit for communication with an external device. In addition, the wearable display device 100 may communicate with the external device via the communication unit. The wearable display device 100 may receive event information from the external device and identify an event object based on the received event information.

In FIG. 7, a newspaper vending machine may communicate with the wearable display device 100. The newspaper vending machine is an external device and may allow the wearable display device 100 to identify the newspaper vending machine as an event object. For example, the newspaper vending machine may transmit event information to the wearable display device 100. The event information may include an image and/or position of the real object 250 that is identified as the event object. The wearable display device 100, which has received the event information from the newspaper vending machine, identifies the newspaper vending machine, i.e. the real object 250 as the event object. In addition, the wearable display device 100 may display the content 210 adjacent to the identified event object.

For example, a product stall as an external device may communicate with the wearable display device 100. The product stall may allow the wearable display device 100 to identify a specific product as an event object. The wearable display device 100 may display the content 210 adjacent to the specific product to correspond to the identified event object.

FIG. 8 is a view showing variation of a display position of content depending on movement of the user.

When the identified event object is no longer sensed by the image sensing unit, the wearable display device 100 may display the content 210 by moving the content 210, which has been displayed at a moved position, to an original display position of the content 210.

In FIG. 8, the identified event object is a traffic light, i.e. the external real object 250. The user of the wearable display device 100 crosses the street at a crosswalk while watching the content 210. First, in (a) of FIG. 8, the wearable display device 100 displays the content 210 adjacent to the identified real object 250. As such, the user's gaze is naturally directed to the traffic light. In (b) of FIG. 8, a signal of the traffic light is changed from a stop signal to a pedestrian signal and the user of the wearable display device 100 begins to cross the street at a crosswalk. That a display position of the content 210 may be moved based on movement of the user of the wearable display device 100 has been described above with reference to FIGS. 4 and 5. Once the user crosses the street at a crosswalk as exemplarily shown in (c) of FIG. 8, the event object (the real object 250) may no longer be sensed by the wearable display device 100. As such, the wearable display device 100 may display the content 210 at an original position. Accordingly, movement of a display position of the content 210 caused by identification of the event object may end when the event object is no longer sensed.

In addition, the wearable display device 100 may again move the moved display position of the content 210 to the original position when a distance between the identified event object and the wearable display device 100 is a predetermined distance or less. For example, the content 210 is moved to and displayed at a position adjacent to the real object 250 in (a) of FIG. 8. In (b) of FIG. 8, a distance between the wearable display device 100 and the real object 250 is reduced via movement of the user. In (c) of FIG. 8, a distance between the wearable display device 100 and the real object 250 is reduced to a predetermined distance or less. As such, the wearable display device 100 may display the content 210, which has been displayed at the moved position, at the original position. Accordingly, movement of a display position of the content 210 caused by identification of the event object may end when a distance between the event object and the content 210 is a predetermined distance or less.

FIG. 9 is a view showing a cancel interface according to one embodiment.

The wearable display device 100 may provide a cancel interface 220 to cancel movement of a display position when a display position of the content 210 is moved based on identification of an event object.

For example, as exemplarily shown in FIG. 9, the wearable display device 100 may display the cancel interface 220 adjacent to the displayed content 210. The wearable display device 100 may move a display position of the moved content 210 to an original position of the content 210 upon receiving input to the cancel interface 220. For example, input to the cancel interface 220 may be received based on the user's eyes and/or hand's gestures.

The cancel interface 220 of FIG. 9 is given by way of example and the cancel interface 220 may be provided as visual, auditory or olfactory feedback. In addition, the user of the wearable display device 100 may input visual motion (for example, behavior of stretching the hand) or voice to the cancel interface 220.

The operations of the wearable display device 100 as described above with reference to FIGS. 3 to 9 may be combined with one another and may be performed by the components of the wearable display device 100 as described above with reference to FIGS. 1 and 2.

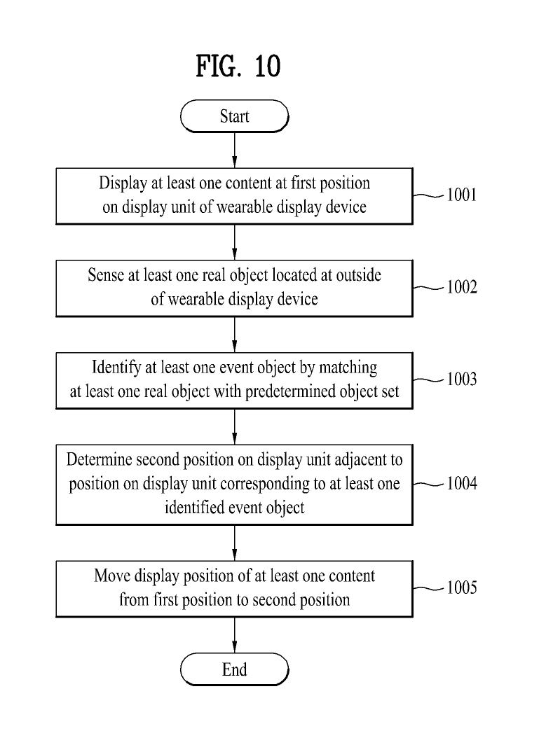

FIG. 10 is a flowchart showing a control method of the wearable display device according to one embodiment of the present specification.

The wearable display device may display at least one content at a first position on the display unit thereof (1001). The first position may be a predetermined position. In addition, the wearable display device may include the components as described above with reference to FIGS. 1 and 2. In addition, the wearable display device may sense at least one real object located outside thereof (1002). The wearable display device may sense the real object using the image sensing unit. The wearable display device may identify at least one event object by matching the at least one real object with a predetermined object set (1003). As described above with reference to FIGS. 3 and 4, the wearable display device may sense various real objects and include various object sets.

In addition, the wearable display device may determine a second position on the display unit adjacent to a position on the display unit corresponding to the at least one identified event object. That the second position may be determined so as not to overlap with the event object has been described above with reference to FIG. 4. The wearable display device moves a display position of the at least one content from the first position to the second position. That movement of the display position may be gradually performed has been described above with reference to FIG. 4.

In addition, the operations of the wearable display device as described above with reference to FIGS. 3 to 9 may be combined with the control method of the wearable display device as described above with reference to FIG. 10, and the control method of the wearable display device may be performed by the wearable display device as described above with reference to FIGS. 1 and 2.

As is apparent from the above-described embodiments, a wearable display device according to the present specification may provide an improved user experience by adjusting display of content based on a user situation.

The wearable display device and the control method thereof according to the present specification should not be limited to configurations and methods of the above embodiments and all or some of the respective embodiments may be selectively combined to achieve various modifications.

Meanwhile, the wearable display device and the control method thereof according to the present specification may be implemented as software in a recording medium that can be read by a processor provided in the wearable display device. The processor readable recording medium may be any type of recording device in which data is stored in a processor readable manner. Examples of the processor readable recording medium may include a ROM, a RAM, a CD-ROM, a magnetic tape, a floppy disc, and an optical data storage device. In addition, the processor readable recording medium includes a carrier wave (e.g., data transmission over the Internet). Also, the processor readable recording medium may be distributed over computer systems connected to a network so that processor readable code is stored therein and executed therefrom in a decentralized manner.

Although the exemplary embodiments have been illustrated and described as above, of course, it will be apparent to those skilled in the art that the present specification is not limited to the above described particular embodiments, and various modifications and variations can be made in the present specification without departing from the spirit or scope of the present specification, and the modifications and variations should not be understood individually from the viewpoint or scope of the present specification.

What is claimed is:

1. A wearable display device comprising:
a display unit configured to display at least one content;
an image sensing unit configured to sense at least one real object located outside of the wearable display device; and
a processor configured to control the display unit and the image sensing unit,
wherein the processor is further configured to:
display the at least one content at a first position on the display unit;
identify at least one event object by matching the at least one real object sensed by the image sensing unit with a predetermined object set;
determine a second position on the display unit adjacent to a position on the display unit corresponding to the at least one identified event object; and
move a display position of the at least one content from the first position to the determined second position on the display unit, and
wherein the at least one content and the at least one event object are irrelevant to each other.

2. The device according to claim 1, wherein the processor is further configured to match the at least one real object with the predetermined object set based on at least one of a size, shape and color of the at least one real object.

3. The device according to claim 1, wherein the processor is further configured to determine the second position based on a display size of the at least one content and a position of the at least one event object such that the displayed content does not overlap with the at least one event object on the display unit.

4. The device according to claim 1, wherein the processor is further configured to gradually move the display position of the at least one content from the first position to the second position.

5. The device according to claim 1, wherein the processor is further configured to:
detect movement of the at least one event object on the display unit; and
move the determined second position based on the detected movement of the at least one event object.

6. The device according to claim 4, wherein the processor is further configured to:
detect movement of the at least one event object on the display unit;
move the determined second position based on the detected movement of the at least one event object; and
gradually move the display position of the at least one content such that a current display position of the at least one content coincides with the moved second position.

7. The device according to claim 1, further comprising a sound output unit,
wherein the processor is further configured to provide a sound alarm via the sound output unit when the display position of the at least one content is moved to the second position.

8. The device according to claim 1, further comprising a communication unit configured to communicate with an external device,
wherein the processor is further configured to:
receive event information from the external device; and
identify the event object based on the received event information.

9. The device according to claim 1, wherein the processor is further configured to adjust at least one of brightness, transparency and a size of the at least one content displayed on the second position to a predetermined value.

10. The device according to claim 1, wherein each object of the predetermined object set includes at least one of a number, a letter, a symbol, a 2D image and a 3D image.

11. The device according to claim 10, wherein the predetermined object set includes objects associated with safety warnings, and
wherein the objects associated with the safety warnings comprise at least one of a traffic signal, a traffic sign, a warning and a warning image.

12. The device according to claim 11, wherein the processor is further configured to:
identify a traffic light as the event object; and
display the at least one content, which has been displayed at the second position, at the first position on the display unit when a distance between the identified event object and the wearable display device is a predetermined distance or less.

13. The device according to claim 10, wherein the predetermined object set includes objects associated with user convenience, and
wherein the objects associated with the user convenience comprise at least one of a vehicle, a letter on the vehicle, a train number, a gate number, an address sign and a road sign.

14. The device according to claim 13, wherein the processor is further configured to identify a predetermined bus as the event object based on at least one of a bus number, a bus shape and a destination written on the bus.

15. The device according to claim 10, wherein the predetermined object set includes objects associated with advertisement, and
wherein the objects associated with advertisement comprise at least one of a product, an advertisement image, a product name and a building.

16. The device according to claim 10, wherein the processor is further configured to:
sense a new image using the image sensing unit;
receive selection of an external real object contained in the sensed image; and
add the new external real object to the predetermined object set based on the selection.

17. The device according to claim 1, wherein the processor is further configured to move the display position of the at least one content, which has been displayed at the second position, from the second position to the first position when the at least one identified event object is not sensed by the image sensing unit.

18. The device according to claim 1, wherein the processor is further configured to display the at least one content, which has been displayed at the second position, at the first position on the display unit when a distance between the identified event object and the wearable display device is a predetermined distance or less.

19. The device according to claim 1, wherein the processor is further configured to display a cancel interface on the display unit, the cancel interface triggering redisplay of the at least one content, which has been displayed at the second position, at the first position.

20. A control method of a wearable display device, the method comprising:
displaying at least one content at a first position on a display unit of the wearable display device;
sensing at least one real object located outside of the wearable display device;
identifying at least one event object by matching the at least one sensed real object with a predetermined object set;
determining a second position on the display unit adjacent to a position on the display unit corresponding to the at least one identified event object; and
moving a display position of the at least one content from the first position to the determined second position on the display unit,
wherein the at least one content and the at least one event object are irrelevant to each other.
